(19) United States
(12) Patent Application Publication
(10) Pub. No.: US 2019/0324795 A1
(43) Pub. Date: Oct. 24, 2019

(54) COMPOSITE TASK EXECUTION

(71) Applicant: Microsoft Technology Licensing, LLC, Redmond, WA (US)

(72) Inventors: Jianfeng GAO, Woodinville, WA (US); Xiujun LI, Bellevue, WA (US); Lihong LI, Redmond, WA (US); Da TANG, New York, NY (US); Chong WANG, Bellevue, WA (US); Tony JEBARA, Los Gatos, CA (US)

(73) Assignee: Microsoft Technology Licensing, LLC, Redmond, WA (US)

(21) Appl. No.: 15/960,809

(22) Filed: Apr. 24, 2018

(51) Int. Cl. G06F 9/48; G06F 9/50; G06F 17/30; G06F 17/28; G06N 3/02; G10L 15/22

(52) U.S. Cl. CPC G06F 9/4843; G06F 9/5066; G06F 17/30976; G10L 2015/223; G06N 3/02; G10L 15/22; G06F 17/28

(57) ABSTRACT

A system for executing composite tasks can include a processor to detect a composite task from a user. The processor can also detect a plurality of subtasks corresponding to the composite task based on unsupervised data without a label, wherein the plurality of subtasks are identified by a top-level dialog policy. The processor can also detect a plurality of actions, wherein each action is to complete one of the subtasks, and wherein each action is identified by a low-level dialog policy corresponding to the subtasks identified by the top-level dialog policy. The processor can also update a dialog manager based on a completion of each action corresponding to the subtasks and execute instructions based on a policy identified by the dialog manager, wherein the executed instructions implement the policy with a lowest global cost corresponding to the composite task provided by the user.

### BACKGROUND

Computer devices can use machine learning techniques to progressively improve the performance of executing a specific task. For example, machine learning techniques can improve identifying search query results, optical character recognition, ranking algorithms, and computer vision, among others. In some examples, artificial intelligence can be implemented by computing devices to perceive an environment and determine actions to take to maximize a chance of successfully achieving a predetermined goal.

### SUMMARY

The following presents a simplified summary in order to provide a basic understanding of some aspects described herein. This summary is not an extensive overview of the claimed subject matter. This summary is not intended to identify key or critical elements of the claimed subject matter nor delineate the scope of the claimed subject matter. This summary's sole purpose is to present some concepts of the claimed subject matter in a simplified form as a prelude to the more detailed description that is presented later.

In one embodiment, a system for executing composite tasks based on computational learning techniques can include a processor to detect a composite task from a user. The processor can also detect a plurality of subtasks corresponding to the composite task based on unsupervised data without a label, wherein the plurality of subtasks are identified by a top-level dialog policy. Additionally, the processor can detect a plurality of actions, wherein each action is to complete one of the subtasks, and wherein each action is identified by a low-level dialog policy corresponding to the subtasks identified by the top-level dialog policy. Furthermore, the processor can update a dialog manager based on a completion of each action corresponding to the subtasks, wherein the dialog manager stores an intrinsic value indicating a sub-cost to execute each action corresponding to each subtask, and an extrinsic value indicating a global cost to execute a plurality of actions that perform the composite task. Moreover, the processor can execute instructions based on a policy identified by the dialog manager, wherein the executed instructions implement the policy with a lowest global cost corresponding to the composite task provided by the user.

In another embodiment, a method for executing composite tasks based on computational learning techniques can include detecting a composite task from a user. The method can also include detecting a plurality of subtasks corresponding to the composite task based on unsupervised data without a label, wherein the plurality of subtasks are identified by a top-level dialog policy. Additionally, the method can also include detecting a plurality of actions, wherein each action is to complete one of the subtasks, and wherein each action is identified by a low-level dialog policy corresponding to the subtasks identified by the top-level dialog policy. Furthermore, the method can also include updating a dialog manager based on a completion of each action corresponding to the subtasks, wherein the dialog manager stores an intrinsic value indicating a sub-cost to execute each action corresponding to each subtask, and an extrinsic value indicating a global cost to execute a plurality of actions that perform the composite task. Moreover, the method can also include executing instructions based on a policy identified by the dialog manager, wherein the executed instructions implement the policy with a lowest global cost corresponding to the composite task provided by the user.

In another embodiment, one or more computer-readable storage media for executing composite tasks based on computational learning techniques can include a plurality of instructions that, in response to execution by a processor, cause the processor to detect a composite task from a user. The plurality of instructions can also cause the processor to detect a plurality of subtasks corresponding to the composite task based on unsupervised data without a label, wherein the plurality of subtasks are identified by a top-level dialog policy. Additionally, the plurality of instructions can also cause the processor to detect a plurality of actions, wherein each action is to complete one of the subtasks, and wherein each action is identified by a low-level dialog policy corresponding to the subtasks identified by the top-level dialog policy. Furthermore, the plurality of instructions can also cause the processor to update a dialog manager based on a completion of each action corresponding to the subtasks, wherein the dialog manager stores an intrinsic value indicating a sub-cost to execute each action corresponding to each subtask, and an extrinsic value indicating a global cost to execute a plurality of actions that perform the composite task. Moreover, the plurality of instructions can also cause the processor to execute instructions based on a policy identified by the dialog manager, wherein the executed instructions implement the policy with a lowest global cost corresponding to the composite task provided by the user.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

The following detailed description may be better understood by referencing the accompanying drawings, which contain specific examples of numerous features of the disclosed subject matter.

FIG. 1 is an example block diagram illustrating a computing device that can execute dialog related composite tasks based on computational learning techniques;

FIG. 2 is an example block diagram illustrating a hierarchical reinforcement learning technique for executing dialog related composite tasks;

FIG. 3 is an example block diagram illustrating states of a hierarchical reinforcement learning technique for executing dialog related composite tasks;

FIG. 4 is a process flow diagram of an example method for executing composite tasks based on computational learning techniques;

FIG. 5 is an example block diagram illustrating states in an unsupervised hierarchical reinforcement learning technique for executing dialog related composite tasks;

FIG. 6 is an example diagram illustrating termination states in an unsupervised hierarchical reinforcement learning technique for executing dialog related composite tasks;

FIG. 7 is a block diagram of an example of a computing system that can execute composite tasks based on computational learning techniques; and

FIG. 8 is a block diagram of an example computer-readable storage media that can execute composite tasks based on computational learning techniques.

### DETAILED DESCRIPTION

The techniques described herein can enable a computing device to identify a series of actions to execute to perform a requested composite task. A composite or complex task, as referred to herein, can include a set of subtasks that are to be fulfilled collectively. For example, a composite task can include an electronic request to perform a set of electronic services. In some examples, the composite task can relate to travel plans that can include electronically reserving airline tickets, reserving hotel accomodations, renting a vehicle, and the like. In some embodiments, a composite task can include any series of interconnected electronic transactions detected from a user dialog such as departure flight ticket booking, return flight ticket booking, hotel reservation booking, and vehical rental booking. In some examples, the composite task can include passenger delivery features such as a taxi implementation associated with a customer pickup location, navigation or directions, a customer drop-off location, and the like. The composite task can be fulfilled in a collective way so as to satisfy a set of cross-subtask constraints, which we call slot constraints. A slot constraint can correspond to any suitable temporal request such as verifying that a hotel check-in time is later than a flight's arrival time, verifying a hotel check-out time is earlier than a return flight departure time, or verifying that a number of flight tickets is equal to that of a number of people present at a hotel check, among others.

Some embodiments described herein include formulating a composite task using a framework of subtasks (also referred to herein as options) over Markov Decision Processes (MDPs), and utilizing a technique that combines deep learning and hierarchical reinforcement learning to train a composite task-completion dialog agent. The techniques described can be implemented by a dialog manager that can include a top-level dialog policy that selects subtasks, a low-level dialog policy that selects actions to complete a given subtask, and a global state tracker that is to ensure the cross-subtask constraints are satisfied. In some examples, the techniques herein include operating the dialog manager with a variety of slot constraints and temporal time scales for each subtask.

The techniques described herein can reduce an amount of processing time to identify a series of actions to execute in order to satisfy a composite task received from another device or a user, among others. In some examples, the techniques described herein can reduce power consumption of a device by reducing a number of instructions to execute in order to identify the series of actions that satisfy a composite task.

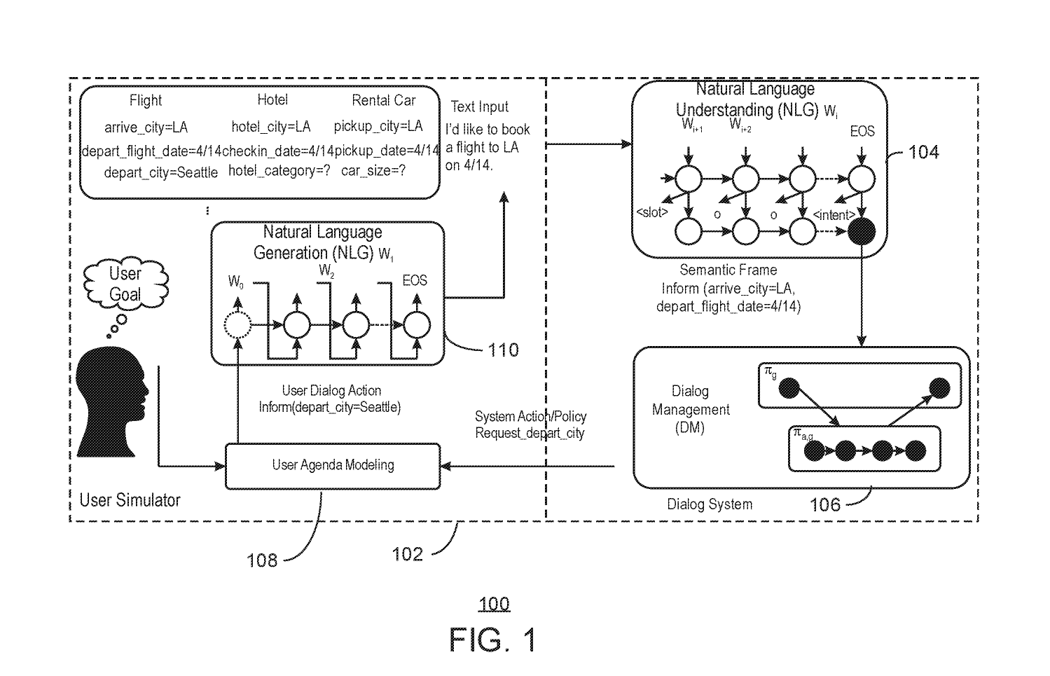

FIG. 1 is an example block diagram illustrating a computing device that can execute dialog related composite tasks based on computational learning techniques. In some embodiments, the computing device 100 can include a user simulator 102, a natural language understanding system 104, and a dialog system 106. In some examples, the user simulator 102 can detect a user dialog or user input such as a verbal input detected by a microphone, a written input detected by a keyboard, and the like. The user simulator 102 can detect the user dialog with a user agenda modeling module 108 that can transmit a composite task included in the user dialog to a natural language generation (NLG) module 110. The NLG module 110 can extract text corresponding to the composite task and forward the text to the natural language understanding (NLU) system 104. For example, the NLU system 104 can detect information from a user dialog such as an arrival or departure city for a flight, a date and time for a flight, a date or a range of dates for a hotel reservation, and a date or a range of dates for a rental car, among others. The NLU system 104 can detect the portions of the composite task that pertain to separate subtasks in the composite task. The NLU system 110 can forward the identified text for each subtask to the dialog system 106.

In some embodiments, the dialog system 106 can include a long short term memory (LSTM) based language understanding module for identifying user intents and extracting associated temporal slots. Additionally, the dialog system 106 can include a dialog policy which selects the next action based on the current state. Furthermore, the dialog system 106 can include a model-based natural language generator for converting agent actions to natural language responses. In some examples, the dialog system 106 can include a global state tracker to maintain the dialog state by accumulating information across the subtasks of the composite task. The state tracker can ensure the inter-subtask constraints are satisfied.

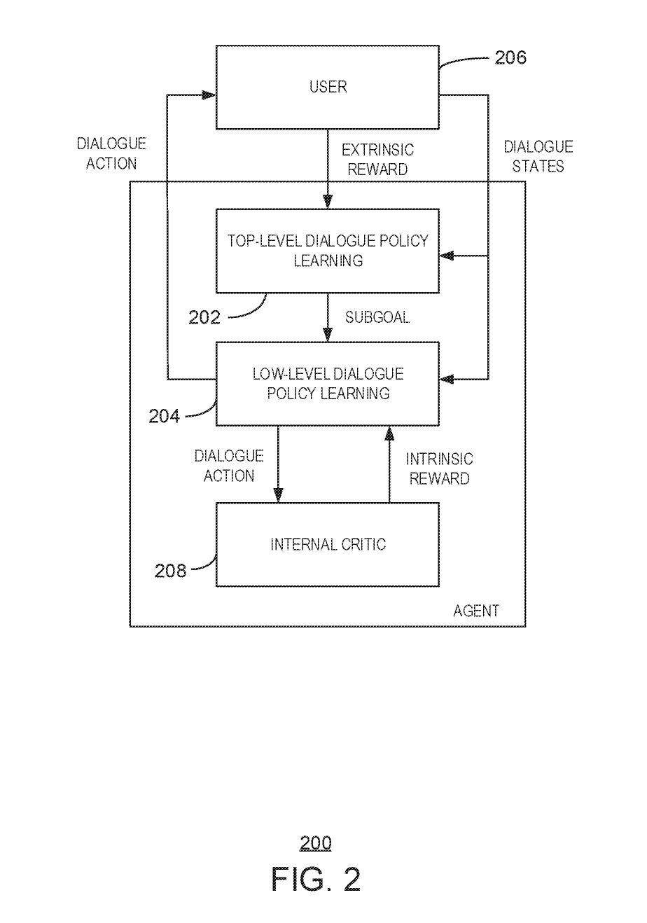

In one example, the dialog system 106 can detect a composite task related to a series of travel planning subtasks. The dialog system 106 can select a subtask (e.g., book flight ticket) and execute a sequence of actions to gather related information (e.g., departure time, number of tickets, destination, etc.) until the users' constraints are met and the subtasks are completed. The dialog system 106 can also select a subsequent subtask (e.g., reserve hotel) to complete. The dialog system 106 can indicate that a composite task is complete if the subtasks of the composite task are collectively completed. As discussed in greater detail below in relation to FIG. 2, the techniques described herein are implemented by a hierachical process comprising a top-level process that selects which subtasks to complete and a low-level process that selects actions to complete the selected subtasks. In some examples, the hierarchical process can be formulated in an options framework, where options generalize primitive actions to higher-level actions. Rather than a traditional Markov Decision Process setting in which an agent can only choose a primitive action at each time step, the present techniques use options that enable selecting a “multi-step” action such as a sequence of primitive actions for completing a subtask, among others.

In some embodiments, an option can include various components such as a set of states where an option can be initiated, an intra-option policy that selects primitive actions while the option is in control, and a termination condition that specifies when the option is completed. For a composite task such as travel planning, subtasks like book flight ticket and reserve hotel can be modeled as options. In one example, an option book flight ticket can include an initiation state set that includes states in which the tickets have not been issued or the destination of the trip exceeds a predetermined threshold distance indicating a flight is preferred. The option can also include an intra-option policy for requesting or confirming information regarding a departure date and the number of seats, etc. The option can also include a termination condition for confirming that the information is gathered and accurate so that a dialog system can issue flight tickets. The dialog system 106 can transmit a system action or policy to the user agenda modeling module 108 to complete the composite task based on identified options.

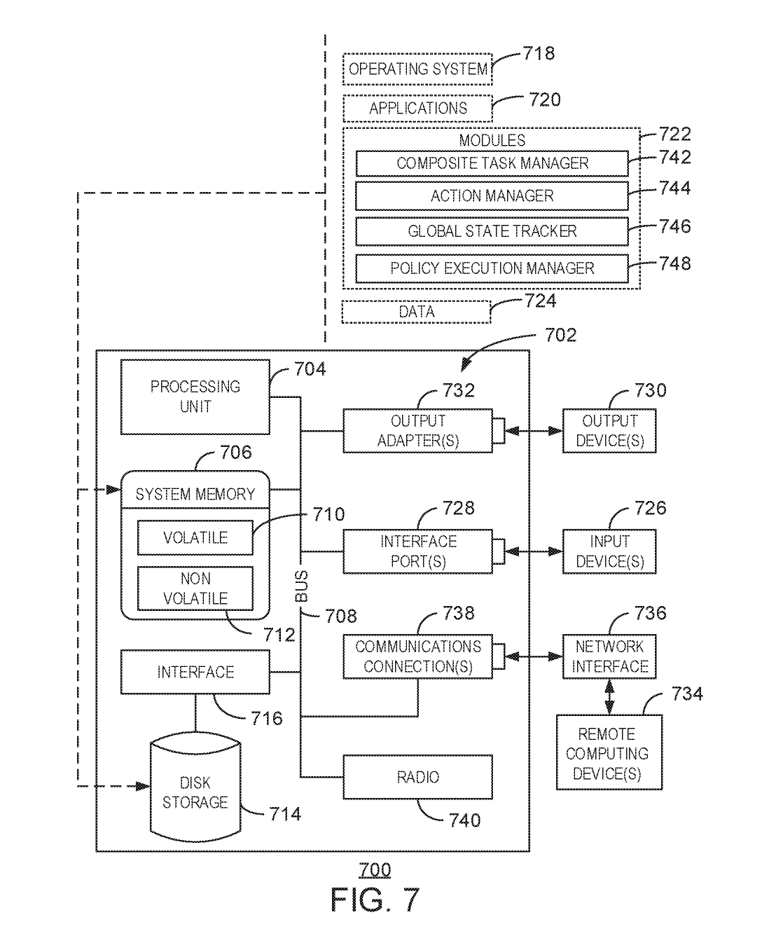

FIG. 2 is an example block diagram illustrating a hierarchical reinforcement learning technique for executing dialog related composite tasks. The agent 200 can be implemented with any suitable computing device or agent such as computing system 700 of FIG. 7 described below.

The agent 200 can implement an intra-option policy over primitive actions and an inter-option policy over sequences of options. The agent 200 can combine deep reinforcement learning and hierarchical value functions to generate a composite task-completion dialog agent. The agent 200 can be a two-level hierarchical reinforcement learning agent that includes a top-level dialog policy 202 and a low-level dialog policy 204, as shown in FIG. 2. For example, the top-level dialog policy 202 and the low-level dialog policy 204 can enable identifying actions to execute to satisfy a composite task provided by a user 206, such as a query request to perform a complex operation. The complex operation can include executing a series of electronic transactions, retrieving a series of information from one or more databases, and the like.

In some embodiments, the agent 200 can implement an options framework related to a composite task-completion dialog agent via hierarchical reinforcement learning (HRL) using human-defined subgoals. For example, the agent 200 can use a hierarchical dialog policy that includes a top-level dialog policy 202 that selects among subtasks (also referred to herein as subgoals), and a low level policy 204 that selects primitive actions to accomplish the subgoal provided by the top level policy.

In some embodiments, the top level policy 202 π_{g} can detect state s, which indicates a current subtask to execute, from an environment and select a subgoal g for the low level policy to execute the subtask. In some examples, the agent 200 can then receive an extrinsic reward r^{e} in response to completing state s and transition to state s′. In some embodiments, the low-level dialog policy π_{a,g} 204 can be shared by each of the options. The low level policy 204 can detect an input such as a state s and a subgoal g. The low level policy 204 can also select a primitive action a to execute. In some examples, the agent 200 can receive an intrinsic reward rⁱ provided by the internal critic 208 of the agent 200 and update the state. The subgoal g can remain a constant input to the low level policy 204 π_{a,g} until a termination state is reached to terminate subgoal g.

In some embodiments, the agent 200 can determine policies, π*_{g} and π*_{a,g} to maximize expected cumulative discounted extrinsic and intrinsic rewards, respectively. In some examples, the agent 200 can achieve this by approximating the discounted extrinsic and intrinsic rewards corresponding to Q-value functions using DQN. For example, the agent 200 can use deep neural networks to approximate the two Q-value functions: O*ₑ(s, g)≈Qₑ(s, g; θ^{e}) for top-level dialog policy and Q*ᵢ(s, g, a)≈Qᵢ (s, g,a;θⁱ) for low-level dialog policy. The parameters θ^{e} and θⁱ can minimize the following quadratic loss functions:

$$\begin{matrix}{min}_{{θ}^{e}} {L}^{e} ( {θ}^{e} ) = \frac{1}{2} {E}_{( s , g , {s}^{′} , {r}^{e} ) : {D}^{e}} [ {( {y}^{e} - {Q}_{e} ( s , g ; {θ}^{e} ) )}^{2} ] , & Eq . ( 1 ) \\ where y = {r}^{e} + γ \cdot {max}_{{g}^{′} ∈ G} {Q}_{e} ( {s}^{′} , {g}^{′} ; {θ}^{e} ) , & \\ {min}_{{θ}^{i}} {L}^{i} ( {θ}^{i} ) = \frac{1}{2} {E}_{( s , a , g , {s}^{′} , {r}^{i} ) : {D}^{i}} [ {( {y}^{i} - {Q}_{i} ( s , g , a ; {θ}^{i} ) )}^{2} ] , & Eq . ( 2 ) \\ where {y}^{i} = {r}^{i} + γ \cdot {max}_{{a}^{′} ∈ A} {Q}_{i} ( {s}^{′} , g , {a}^{′} ; {θ}^{i} ) . & \end{matrix}$$

In Eq. 1 and Eq. 2, γ∈[0,1] is a discount factor, and D^{e}, Dⁱ are the replay buffers storing dialog experience for training top-level and low-level policies, respectively. The gradients of the two loss functions with respect to their parameters are:

$$\begin{matrix}{∇}_{{θ}^{e}} {L}^{e} ( {θ}^{e} ) = {E}_{( s , g , {s}^{′} , {r}^{e} ) : {D}^{e}} [ {∇}_{{θ}^{e}} {Q}_{e} ( s , g ; {θ}^{e} ) \cdot ( {r}^{e} + γ \cdot {max}_{{g}^{′} ∈ G} {Q}_{e} ( {s}^{′} , {g}^{′} ; {θ}^{e} ) - {Q}_{e} ( s , g , a ; {θ}^{e} ) ) ] , & Eq . ( 3 ) \\ {∇}_{{θ}^{i}} {L}^{i} ( {θ}^{i} ) = {E}_{( s , a , g , {s}^{′} , {r}^{i} ) : {D}^{i}} [ {∇}_{{θ}^{i}} {Q}_{i} ( s , g , a ; {θ}^{i} ) \cdot ( {r}^{i} + γ \cdot {max}_{{a}^{′} ∈ A} {Q}_{i} ( {s}^{′} , g , {a}^{′} ; {θ}^{i} ) - {Q}_{i} ( s , g , a ; {θ}^{i} ) ) ] . & Eq . ( 4 )\end{matrix}$$

In some embodiments, the agent 200 can define the extrinsic and intrinsic rewards as follows. If L is the maximum number of turns of a dialog, then K can be the number of subgoals. At the end of a dialog, the agent 200 can receive a positive extrinsic reward of 2L for a successful dialog that completes a subtask, or −L for a failure dialog that fails to complete a subtask. Additionally, for each iteration, the agent 200 can receive an extrinsic reward, such as −1, as a penalty for using a larger number of iterations to satisfy a subtask. In some examples, when the end of an option is reached, the agent 200 can receive a positive intrinsic reward of 2L/K if a subgoal is completed successfully, or a negative intrinsic reward of −2L/K otherwise. Additionally, for reach iteration, the agent 200 can receive an intrinsic reward, such as −1 to discourage longer dialogs. In some examples, an instrinsic reward can be generated based on the probability that a subtask can lead to a termination state. In some examples, either the subtasks are unknown or the human-defined subtasks are sub-optimal, and thus the subtasks are discovered or refined automatically.

In some examples, a combination of the extrinsic and intrinsic rewards defined above results in the agent 200 executing a composite task as fast as possible while minimizing a number of switches between subgoals or subtasks. In the cases where the subgoals of a composite task are manually defined, the agent 200 can detect whether an option is about to terminate. For example, assume that a subtask is defined by a set of slots. In one example, detecting whether an option is about to terminate can include determining whether each of the slots of the subtask are captured in a dialog state.

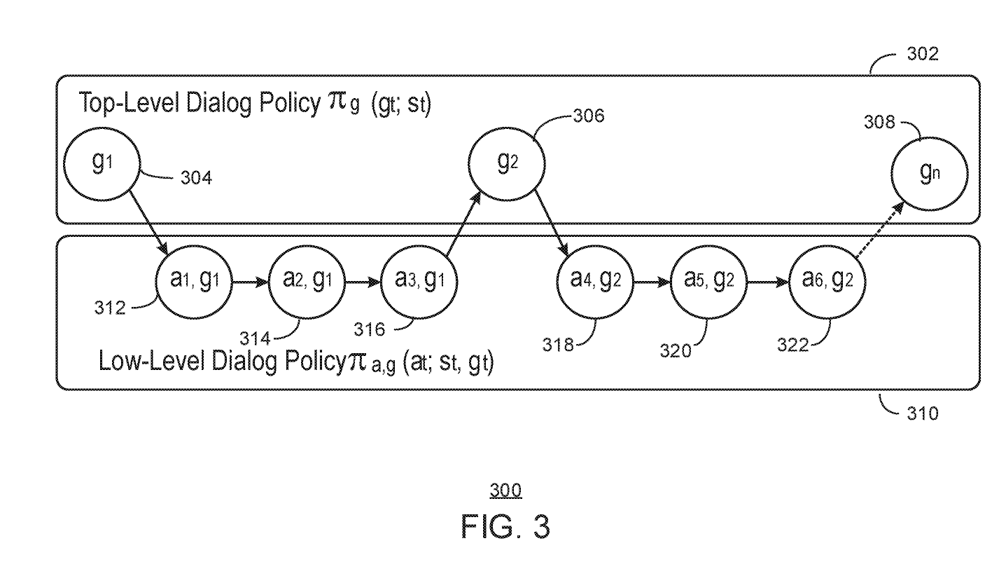

FIG. 3 is an example block diagram illustrating states of a hierarchical reinforcement learning technique for executing dialog related composite tasks. The hierarchical reinforcement learning technique 300 can be implemented with any suitable computing device or agent such as computing system 700 of FIG. 7 described below.

In some embodiments, the top-level dialog policy π_{g} 302 detects state s from an environment and selects a subtask g∈G, where G is the set of the possible subtasks. For example, the top level policy 302 can select subtasks g1 304, g2 306, or gn 308. The top-level dialog policy π_{a,g} 302 can be shared by the options of a low level policy 310. The low level policy 310 can detect input such as a state s and a subtask g, and output a primitive action a∈A, where A is the set of primitive actions of the subtasks. The subtask g can remain a constant input to the low level policy π_{a,g} 302 until a terminal state is reached to terminate g. For example, the low level policy 310 can detect a state s and a subtask g1, which can result in the low level policy 310 selecting actions a1 312, a2 314, and a3 316. The action a3 316 can terminate the multi-step action corresponding to subtask g1 304 and state 3. Similarly, state s′ and subtask g2 306 can result in the low level policy 310 selecting actions a4 318, a5 320, and a6 322 as a multi-step action to execute for subtask g2 306.

In some embodiments, an internal critic in an agent or dialog manager can provide an intrinsic reward rₜⁱ (gₜ) indicating whether the subtask g has been completed by a multi-step action in a low level policy 310, which can be used to optimize the low level policy 310. In some examples, the state s contains global information, in that the state s keeps track of information for each of the subtasks. In some examples, an agent can maximize the following cumulative intrinsic reward of the low-level dialog policy 310 at each step t:

$${max}_{{π}_{a , g}} E [ {\sum }_{k \geq 0} {γ}^{k} {r}_{t + k}^{i} \vert {s}_{t} = s , {g}_{t} = g , {a}_{t + k} = {π}_{a , g} ( {s}_{t + k} ) ] , \qquad Eq . ( 5 )$$

In Eq. 5, rₜ₊ₖⁱ denotes the reward provided by the internal critic at step t+k. Similarly, the agent can maximize the cumulative extrinsic reward for the top-level dialog policy 302 at each step t:

$${max}_{{π}_{g}} E [ {\sum }_{k \geq 0} {γ}^{k} {r}_{t + k}^{e} \vert {s}_{t} = s , {a}_{t + k} = {π}_{g} ( {s}_{t + k} ) ] , \qquad Eq . ( 6 )$$

In Eq. 6, the value calculated as rₜ₊ₖ^{e} is the reward received from the environment at step t+k when a new subtask is initiated.

Both the top-level dialog policy 302 and low-level dialog policy 310 can be generated by any suitable deep learning reinforcement technique such as a deep Q-learning technique or a deep Q-Network, among others. For example, the top-level dialog policy 302 can estimate the Q-function that satisfies the following:

$${Q}_{1}^{*} ( s , g ) = E [ {\sum }_{k = 0}^{N - 1} {γ}^{k} {r}_{t + k}^{e} + {γ}^{N} \cdot {max}_{{g}^{′}} {Q}_{1}^{*} ( {s}_{t + N} , {g}^{′} ) \vert {s}_{t} = s , {g}_{t} = g ] , \qquad Eq . ( 7 )$$

In Eq. 7, N is the number of steps that the low-level dialog policy 304 (intra-option policy) uses to accomplish the subtask. In some examples, g′ is the agent's next subtask in state s_{t+N}. Similarly, the low-level dialog policy 310 can estimate the Q-function that satisfies the following:

$${Q}_{2}^{*} ( s , a , g ) = E [ {r}_{t}^{i} + γ \cdot {max}_{{a}_{t + 1}} {Q}_{2}^{*} ( {s}_{t + 1} , {a}_{t + 1} , g ) \vert {s}_{t} = s , {g}_{t} = g ] . \qquad Eq . ( 8 )$$

In some embodiments, both Q*₁(s, g) and Q*₂(s, a, g) are represented by neural networks, Q₁(s,g;θ₁) and Q₂(s,a,g;θ₂), parameterized by θ₁ and θ₂, respectively. The top-level dialog policy 302 can minimize the following loss function at each iteration i:

$$\begin{matrix}{L}_{1} ( {θ}_{1 , i} ) = {E}_{( s , g , {r}^{e} , {s}^{′} ) : {D}_{1}} [ {( {y}_{i} - {Q}_{1} ( s , g ; {θ}_{1 , i} ) )}^{2} ] & Eq . ( 9 ) \\ {y}_{i} = {r}^{e} + {γ}^{N} {max}_{{g}^{′}} {Q}_{1} ( {s}^{′} , {g}^{′} , {θ}_{1 , i - 1} ) & Eq . ( 10 )\end{matrix}$$

As in Eq. 7, r^{e}=Σₖ₌₀^{N-1}γ^{k}rₜ₊ₖ^{e} is the discounted sum of reward collected when subgoal g is being completed, and N is the number of steps to complete g. In some examples, the low-level dialog policy 310 can minimize the following loss at each iteration i using:

$$\begin{matrix}{L}_{2} ( {θ}_{2 , i} ) = {E}_{( s , g , a , {r}^{i} , {s}^{′} ) : {D}_{2}} [ {( {y}_{i} - {Q}_{2} ( s , g , a ; {θ}_{2 , i} ) )}^{2} ] & Eq . ( 11 ) \\ {y}_{i} = {r}^{i} + γ {max}_{{a}^{′}} {Q}_{2} ( {s}^{′} , g , {a}^{′} , {θ}_{2 , i - 1} ) & Eq . ( 12 )\end{matrix}$$

In some examples, an agent can use SGD to minimize the above loss functions. For example, the gradient for the top-level dialog policy 302 can yield:

$${∇}_{{θ}_{1 , i}} {L}_{1} ( {θ}_{1 , i} ) = {E}_{( s , g , {r}^{e} , {s}^{′} ) : {D}_{1}} [ ( {r}^{e} + {γ}^{N} {max}_{{g}^{′}} {Q}_{2} ( {s}^{′} , {g}^{′} , {θ}_{1 , i - 1} ) - {Q}_{1} ( s , g , {θ}_{1 , i} ) ) {∇}_{{θ}_{1 , i}} {Q}_{1} ( s , g , {θ}_{1 , i} ) ] \qquad Eq . ( 13 )$$

In some examples, the gradient for the low-level dialog policy 310 can yield:

$${∇}_{{θ}_{2 , i}} {L}_{2} ( {θ}_{2 , i} ) = {E}_{( s , g , a , {r}^{i} , {s}^{′} ) : {D}_{2}} [ ( {r}^{′} + γ {max}_{{a}^{′}} {Q}_{2} ( {s}^{′} , g , {a}^{′} , {θ}_{2 , i - 1} ) - {Q}_{2} ( s , g , a , {θ}_{2 , i} ) ) {∇}_{{θ}_{2 , i}} {Q}_{2} ( s , g , a , {θ}_{2 , i} ) ] \qquad Eq . ( 14 )$$

In some embodiments, an agent can apply performance boosting techniques such as target networks and experience replay. In some examples, experience replay tuples (s,g,r^{e}, s′) and (s,g,a,rⁱ, s′) are sampled from the experience replay buffers D₁ and D₂ respectively.

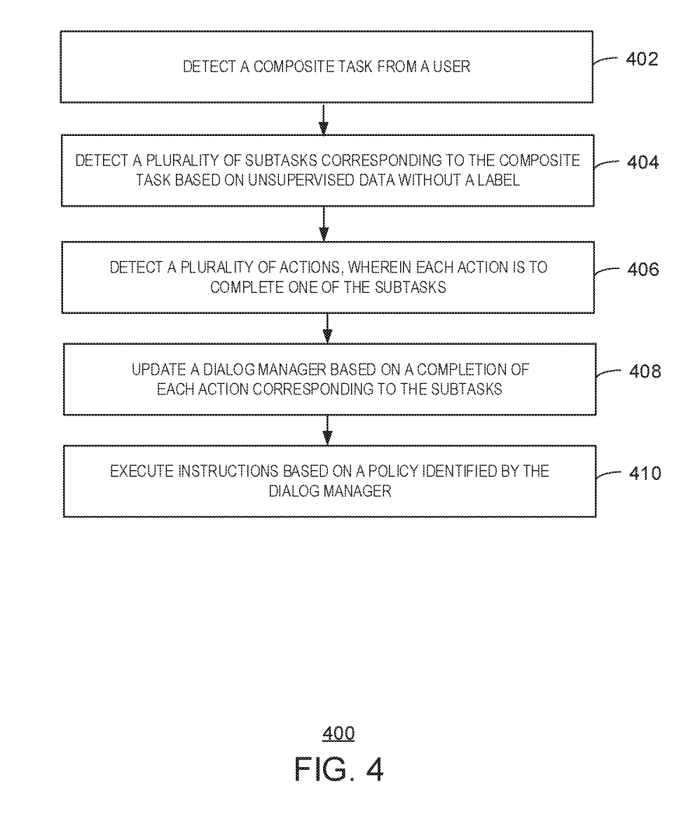

FIG. 4 is a process flow diagram of an example method for executing composite tasks based on computational learning techniques. The method 400 can be implemented with any suitable computing device, such as the computing system 702 of FIG. 7, described below.

At block 402, a device can detect a composite task from a user, wherein the composite task comprises a plurality of subtasks identified by a top-level dialog policy. A composite task can include any task detected from input such as a natural language dialog request detected by a microphone, a written request detected by a keyboard or any other suitable input device, and the like. The composite task can indicate a task that corresponds to multiple actions to be taken, wherein each action may have different temporal constraints. For example, a composite task can correspond to electronically requesting a reservation for a series of flights, hotels, and vehicle rentals, among others. In some embodiments, the composite task can correspond to a user request that corresponds to multiple interdependent instructions. For example, a composite task can include global constraints that ensure a first action related to completion of a composite task is executed and terminated prior to executing a second action. In some embodiments, the device can generate a first neural network for the high level dialog and a second neural network for a low level dialog.

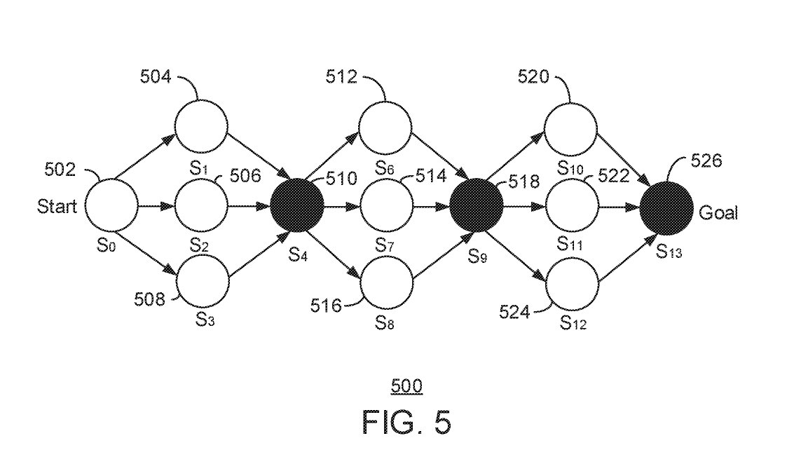

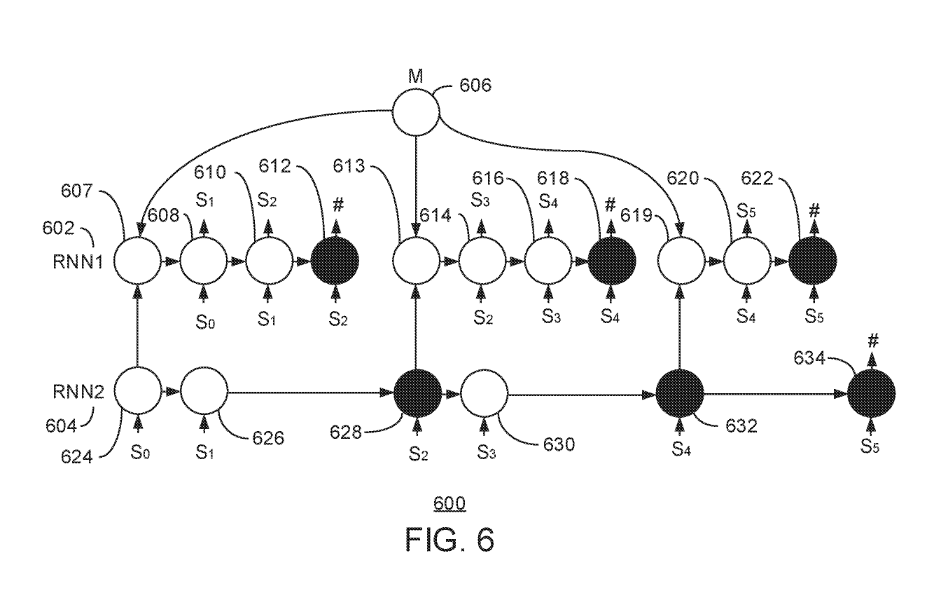

At block 404, a device can detect a plurality of subtasks corresponding to the composite task based on unsupervised data without a label, wherein the plurality of subtasks are identified by a top-level dialog policy. In some examples, the device can detect a number of the plurality of subtasks based on a predetermined upper limit on a maximum number of allowed segmentations. In some examples, the device can calculate a probability that each of the subtasks is to output a termination symbol, and terminate a multi-step action or option in response to detecting the probability of outputting the termination symbol is above a threshold value. Selecting subtasks using unsupervised techniques is described in greater detail below in relation to FIGS. 5 and 6.

At block 406, a device can detect a plurality of actions, wherein each action is to complete one of the subtasks. In some embodiments, each action is identified by a low-level dialog policy corresponding to the subtasks identified by a top-level dialog policy. In some examples, each action can be a multi-step action. For example, a multi-step action can execute a subtask related to a composite task such as a dialog request. In some examples, the multi-step action can include electronically confirming or requesting information from any suitable number of databases or external devices. The devices can store information in databases related to any suitable dialog request such as electronically securing a hotel room, a flight, and the like.

At block 408, a device can update a dialog manager based on a completion of each action corresponding to the subtasks, wherein the dialog manager stores an intrinsic value indicating a sub-cost to execute each action corresponding to each subtask, and an extrinsic value indicating a global cost to execute a plurality of actions that perform the composite task. The intrinsic value can indicate a cost to execute any suitable action or multi-step action to perform a subtask. As discussed above in relation to FIGS. 2 and 3, an intrinsic reward or an intrinsic value can be generated by an internal critic of an agent, wherein the internal critic assigns an intrinsic reward to actions or multi-actions that complete a subtask with a minimal number of actions. An extrinsic reward or extrinsic value can indicate a minimal number of actions for a plurality of subtasks corresponding to a composite task. The extrinsic reward or value can be assigned by an agent once a composite task is completed.

In some examples, the device can select each action corresponding to each subtask based on the extrinsic value associated with previously identified actions executed in previous states. In some examples, the device can determine an order of subtasks based on temporal constraints for each of the subtasks. For example, the dialog manager can verify if an order of a series of actions that complete a subtask violate a predetermined temporal constraint. For example, the dialog manager can verify that a hotel room is not reserved for a date preceding a flight to the location of the hotel room, and the like.

At block 410, a device can execute instructions based on a policy identified by the dialog manager, wherein the executed instructions implement the policy with a lowest global cost corresponding to the composite task provided by the user. For example, the executed instructions can complete a composite task with a minimum number of instructions or actions. The policy can indicate a series or sequence of actions to execute that perform a composite task with a least number of actions and subtasks. For example, in response to detecting a dialog from a user requesting a composite task related to electronically reserving a hotel room, a flight, and a rental vehicle, among others, a policy can indicate a series of actions to perform the composite task. The policy can analyze temporal or time constraints regarding each action, such as electronically reserving a hotel room or flight, and select available actions according to the time constraints. For example, the policy can indicate that the device is to communicate with any suitable number databases or external computing devices in a sequential order to electronically secure a plurality of services related to hotel rooms, flights, rental vehicles, and the like.

In one embodiment, the process flow diagram of FIG. 4 is intended to indicate that the blocks of the method 400 are to be executed in a particular order. Alternatively, in other embodiments, the blocks of the method 400 can be executed in any suitable order and any suitable number of the blocks of the method 400 can be included. Further, any number of additional blocks may be included within the method 400, depending on the specific application.

FIG. 5 is an example block diagram illustrating states in an unsupervised hierarchical reinforcement learning technique for executing dialog related composite tasks. In FIG. 5, there are 13 identified dialog states or nodes s0 502, s1 504, s2 506, s3 508, s4 510, s6 512, s7 514, s8 516, s9 518, s10 520, s11 522, s12 524, and s13 526 related to a composite task. In some examples, any number of the dialog states can be completed to complete the composite task. In one example, there may be three state trajectories (s0 502, s1 504, s4 510, s6 512, s9 518, s10 520, s13 526), (s0 502, s2 506, s4 510, s7 514, s9 518, s11 522, s13 526), and (s0 502, s3 508, s4 510, s8 516, s9 518, s12 524, s13 526) that complete a composite task related to a dialog policy. In this example, states s4 510, s9 518, and s13 526 can be identified as candidates for subtasks or subgoals. For example, completion of states s4 510, s9 518, and s13 526 can result in completion of a related composite task. Accordingly, an agent can attempt to complete states s4 510, s9 518, and s13 526 with a minimal number of executed instructions.

FIG. 6 is an example diagram illustrating termination states in an unsupervised hierarchical reinforcement learning technique for executing dialog related composite tasks. In FIG. 6, an agent can use hierarchical policy learning techniques to identify substasks related to a composite task for dialog applications. In one example, an agent can identify a set of successful state trajectories of a composite task shown in FIG. 5. In some examples, the agent can determine subgoal states or substates, such as the three states s₄, s₉ and s₁₃, which form the “hubs” of the successful state trajectories. These hub states indicate the ends of subgoals, and thus divide a state trajectory into several segments related to separate subtasks or subgoals.

In some embodiments, an agent can use a subgoal discovery technique such as a Subgoal Discovery Network (SDN) to identify subgoals or substates without interaction from a user or labels. In one example, a state trajectory (s₀, . . . , s₅) can represent a successful dialog as shown in FIG. 6. The candidate subgoal states s₂, s₄, and s₅ can divide the trajectory into three segments (s₀, s₁, s₂), (s₂, s₃, s₄) and (s₄, s₅). An agent can indicate that each segment is generated by a multi-step action, known as an option. For example, a SDN for trajectory (s₀, . . . , s₅) can include s₂, s₄ and s₅ as subgoals. In some examples, any suitable symbol such as an alphanumeric character or #, among others, can indicate a termination of a subgoal.

In some embodiments, a top-level recurring neural network (RNN) such as RNN1 602 can model single segments and a low-level RNN, such as RNN2 604, can provide information about previous states from RNN1 602. In some examples, an embedding matrix M 606 maps the output of RNN2 604 to low dimensional representations so as to be consistent with the input dimensionality of the RNN1 602. In some examples, each node 607, 608, 610, 612, 613, 614, 616, 618, 619, 620, and 622 of RNN1 602 can indicate a transition form a first subtask to a second subtask. In some embodiments, nodes 607, 613, and 619 correspond to hidden nodes for RNN1 602. Node 608 of RNN1 can indicate a transition from subtask 0 to subtask 1 and node 610 can indicate a transition from subtask 1 to subtask 2. In some embodiments, each node 624, 626, 628, 630, 632, and 634 of RNN2 604 can indicate an action to perform for a corresponding subtask such as s0, s1, s2, s3, s4, or s5. In some examples, a state s5 can be associated with two termination symbols such as #. In one example, a first termination symbol corresponds to the termination of the last segment and a second termination symbol corresponds to the termination of the entire trajectory. The two termination symbols can be used by an agent in a a fully generative model.

As illustrated in FIG. 6, an agent can model the likelihood of each segment using an RNN, such as RNN1 602. At each time step, RNN1 602 can output the next state given the current state until RNN1 602 reaches the option termination symbol #. Since different options are reasonable under different conditions, it is not plausible to apply a fixed initial input to different segments. Accordingly, an agent can use another RNN, such as RNN2 604, to encode the previous states to provide relevant information. The agent can also transform the information or output from RNN2 604 to low dimensional representations as the initial inputs for the RNN1 602 instances. In some examples, the agent can detect a causality assumption of the options framework, which can indicate that the agent can determine the next option given the previous information. The causality assumption may not depend on information related to any later state. The low dimensional representations can be obtained via a global subgoal embedding matrix M∈R^{d×D}, where d and D are the dimensionality of RNN1's 602 input layer and RNN2's 604 output layer, respectively.

In some embodiments, if the output of RNN2 604 at time step t is oₜ, then the RNN1 602 instance starting form time t has M·softmax(oₜ) as its initial input. The softmax value is calculated based on Eq. 14 below.

$${softmax ( {o}_{t} )}_{i} = exp ( {o}_{t , i} ) / {\sum }_{{i}^{′} = 1}^{D} exp ( {o}_{t , {i}^{′}} ) ∈ {R}^{D} for {o}_{t} = ( {o}_{t , 1} , … , {o}_{t , D} ) . \qquad Eq . ( 15 )$$

In Eq. 15, D is the number of subgoals to detect. In some examples, vector softmax(oₜ) in a well-trained SDN can have approximate values to some one-hot vector. A one-hot vector is a vector that indicates a state as corresponding to a single logical “1” with a remainder of values being logical “0.” Therefore, M·softmax(oₜ) can include a value within a threshold range of a column of M 606. In some examples, an agent can detect that M 606 provides at most D different embedding vectors for RNN1 602 as inputs, indicating D different subgoals. In some examples, an agent can select a small D in the case softmax(oₜ) is not within a threshold range of any one-hot vector.

In some embodiments, an agent can detect an SDN assumption that indicates a conditional likelihood of a proposed segmentation σ=((s₀, s₁, s₂),(s₂, s₃, s₄),(s₄, s₅)) is p(σ|s₀)=p((s₀, s₁, s₂)|s₀)·p((s₂, s₃, s₄)|s_{0:2})·p((s₄, s₅)|s_{0:4}), where each probability term p(·|s_{0:i}) is based on an RNN1 602 instance. This conditional likelihood is valid when s₂, s₄ and s₅ are known to be the subgoal states. However, an agent may detect the whole trajectory (s₀, . . . , s₅) as an observation without subgoal states. In some embodiments, an agent can detect a likelihood of the input trajectory (s₀, . . . , s₅) as the sum over thel possible segmentations.

In some embodiments, for an input state trajectory s=(s₀, . . . , s_{T}), an agent can calculate a likelihood using the following:

$${L}_{S} ( s ) = {\sum }_{σ ⊆ S ( s ) , length ( σ ) \leq S} {\prod }_{i = 1}^{length ( {σ}_{i} )} p ( {σ}_{i} \vert τ ( {σ}_{1 : i} ) ) , \qquad Eq . ( 16 )$$

In Eq. 16, S(s) is the set of the possible segmentations for the trajectory s, σᵢ denotes the i^{th} segment in the segmentation σ, and τ is the concatenation operator. In some embodiments, S is an upper limit on the maximal number of segmentations allowed. In some examples, the value for S can be below a predetermined threshold indicating a maximum number of subgoals.

In some embodiments, an agent can use a maximum likelihood estimation with Eq. 16 for training. In some examples, there can be exponentially many possible segmentations in S(s) and simple enumeration can be computationally prohibitive. Accordingly, in some embodiments, an agent can utilize dynamic programming to compute the likelihood in Eq. 16. For example, an agent can detect a segmentation based on Eq. 17 below, in which a trajectory is denoted as s=(s₀, . . . , s_{T}) and a sub-trajectory (sᵢ, . . . , sₜ) of s is denoted as s_{i:t}.

$${L}_{m} ( {s}_{0 : t} ) = \{ \begin{matrix}{\sum }_{i = 0}^{t - 1} {L}_{m - 1} ( {s}_{0 : i} ) p ( {s}_{i : t} \vert {s}_{0 : i} ) , & m > 0 , \\ I [ t = 0 ] , & m = 0.\end{matrix} \qquad Eq . ( 17 )$$

In Eq. 17, the notation Lₘ(s_{0:t}) indicates the likelihood of sub-trajectory s_{0:t} with no more than m segments and function I[⋅] is the indicator function. The value p(s_{i:t}|s_{0:t}) is the likelihood segment s_{i:t} given previous history, where RNN1 602 models the segment and RNN2 604 models the history as shown in FIG. 6. With this recursive relation, an agent can compute the likelihood L_{S}(s) for the trajectory s=(s₀, . . . , s_{T}) in O(ST²) time.

In some embodiments, an agent can denote θ^{s} as the model parameters of SDN, which include the parameters of the embedding matrix M 606, RNN1 602 and RNN2 604. Given a set of N state trajectories (s⁽¹⁾, . . . , s^{(N)}), an agent can calculate θ^{s} by minimizing the negative mean log-likelihood with a L₂-regularization term, λ∥θ^{s}∥² where λ>0, using stochastic gradient descent in Equation 18 below:

$${min}_{{θ}^{s}} {L}_{S} ( {θ}^{s} , λ ) = - \frac{1}{N} {\sum }_{i = 1}^{N} log {L}_{S} ( {s}^{( i )} , {θ}^{s} ) + \frac{1}{2} λ {‖ {θ}^{s} ‖}^{2} . \qquad Eq . ( 18 )$$

In some embodiments, an agent can combine a hierarchical policy learning technique with the SDN technique. For example, after the agent determines the SDN, the agent can use the SDN to detect a dialog policy with hierarchical reinforcement learning (HRL). For example, the agent can start from the initial state s₀ and can continue sampling the output from the distribution related to the RNN1 602 until a termination symbol such as #, is generated. As discussed above, the termination symbol can indicate that the agent has reached a subgoal. The agent can then select a new option and repeat the process. This type of naive sampling may allow the option to terminate at some places with a low probability. To stabilize the HRL training technique, an agent can use a threshold p∈(0,1), which directs the agent to terminate an option if the probability of outputting # is at least p. In some examples, a probability threshold can result in better behavior of the HRL agent than the naive sampling method, since the probability threshold has a smaller variance. In HRL training, the agent can use the probability of outputting a termination symbol to decide subgoal termination.

In one example, an HRL agent A can detect a trained SDN M, with an initial state s₀ of a dialog policy, and threshold p. The HRL agent A can initialize an RNN2 instance R₂ with parameters from M and s₀ as the initial input. The HRL agent can also initialize an RNN1 instance R₁ with parameters from M and M·softmax(o₀^{RNN2}) as the initial input, where M is the embedding matrix (from M) and o₀^{RNN2} is the initial output of R₂. For a current state s←s₀, the HRL agent A can select an option o. If the HRL agent A does not reach a termination state or final goal, the HRL agent A can select an action a according to s and o. The HRL agent A can detect a reward r and the next state s′ from the environment. The HRL agent A can then assign s′ to R₂, denote oₜ^{RNN2} as R₂'s latest output and take M·softmax(oₜ^{RNN2}) as R₁'s new input. In one example, p_{s′} can be the probability of outputting the termination symbol #. If p_{s′}≥p, then the HRL agent A can select a new option o. The HRL agent A can re-initialize R₁ using the latest output from R₂ and the embedding matrix M. The HRL agent A can then terminate the process.

Some of the figures describe concepts in the context of one or more structural components, referred to as functionalities, modules, features, elements, etc. The various components shown in the figures can be implemented in any manner, for example, by software, hardware (e.g., discrete logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 7 discussed below, provide details regarding different systems that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, and the like, or any combination of these implementations. As used herein, hardware may include computer systems, discrete logic components, such as application specific integrated circuits (ASICs), and the like, as well as any combinations thereof.

As for terminology, the phrase “configured to” encompasses any way that any kind of structural component can be constructed to perform an identified operation. The structural component can be configured to perform an operation using software, hardware, firmware and the like, or any combinations thereof. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware.

The term “logic” encompasses any functionality for performing a task. For instance, each operation illustrated in the flowcharts corresponds to logic for performing that operation. An operation can be performed using software, hardware, firmware, etc., or any combinations thereof.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any tangible, computer-readable device, or media.

Computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not storage media) may additionally include communication media such as transmission media for wireless signals and the like.

FIG. 7 is a block diagram of an example of a computing system that can execute composite tasks based on computational learning techniques. The example system 700 includes a computing device 702. The computing device 702 includes a processing unit 704, a system memory 706, and a system bus 708. In some examples, the computing device 702 can be a gaming console, a personal computer (PC), an accessory console, a gaming controller, among other computing devices. In some examples, the computing device 702 can be a node in a cloud network.

The system bus 708 couples system components including, but not limited to, the system memory 706 to the processing unit 704. The processing unit 704 can be any of various available processors. Dual microprocessors and other multiprocessor architectures also can be employed as the processing unit 704.

The system bus 708 can be any of several types of bus structure, including the memory bus or memory controller, a peripheral bus or external bus, and a local bus using any variety of available bus architectures known to those of ordinary skill in the art. The system memory 706 includes computer-readable storage media that includes volatile memory 710 and nonvolatile memory 712.

In some embodiments, a unified extensible firmware interface (UEFI) manager or a basic input/output system (BIOS), containing the basic routines to transfer information between elements within the computer 702, such as during start-up, is stored in nonvolatile memory 712. By way of illustration, and not limitation, nonvolatile memory 712 can include read-only memory (ROM), programmable ROM (PROM), electrically programmable ROM (EPROM), electrically erasable programmable ROM (EEPROM), or flash memory.

Volatile memory 710 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 702 also includes other computer-readable media, such as removable/non-removable, volatile/non-volatile computer storage media. FIG. 7 shows, for example a disk storage 714. Disk storage 714 includes, but is not limited to, devices like a magnetic disk drive, floppy disk drive, tape drive, Jaz drive, Zip drive, LS-210 drive, flash memory card, or memory stick.

In addition, disk storage 714 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 714 to the system bus 708, a removable or non-removable interface is typically used such as interface 716.

It is to be appreciated that FIG. 7 describes software that acts as an intermediary between users and the basic computer resources described in the suitable operating environment 700. Such software includes an operating system 718. Operating system 718, which can be stored on disk storage 714, acts to control and allocate resources of the computer 702.

System applications 720 take advantage of the management of resources by operating system 718 through program modules 722 and program data 724 stored either in system memory 706 or on disk storage 714. It is to be appreciated that the disclosed subject matter can be implemented with various operating systems or combinations of operating systems.

A user enters commands or information into the computer 702 through input devices 726. Input devices 726 include, but are not limited to, a pointing device, such as, a mouse, trackball, stylus, and the like, a keyboard, a microphone, a joystick, a satellite dish, a scanner, a TV tuner card, a digital camera, a digital video camera, a web camera, any suitable dial accessory (physical or virtual), and the like. In some examples, an input device can include Natural User Interface (NUI) devices. NUI refers to any interface technology that enables a user to interact with a device in a “natural” manner, free from artificial constraints imposed by input devices such as mice, keyboards, remote controls, and the like. In some examples, NUI devices include devices relying on speech recognition, touch and stylus recognition, gesture recognition both on screen and adjacent to the screen, air gestures, head and eye tracking, voice and speech, vision, touch, gestures, and machine intelligence. For example, NUI devices can include touch sensitive displays, voice and speech recognition, intention and goal understanding, and motion gesture detection using depth cameras such as stereoscopic camera systems, infrared camera systems, RGB camera systems and combinations of these. NUI devices can also include motion gesture detection using accelerometers or gyroscopes, facial recognition, three-dimensional (3D) displays, head, eye, and gaze tracking, immersive augmented reality and virtual reality systems, all of which provide a more natural interface. NUI devices can also include technologies for sensing brain activity using electric field sensing electrodes. For example, a NUI device may use Electroencephalography (EEG) and related methods to detect electrical activity of the brain. The input devices 726 connect to the processing unit 704 through the system bus 708 via interface ports 728. Interface ports 728 include, for example, a serial port, a parallel port, a game port, and a universal serial bus (USB).

Output devices 730 use some of the same type of ports as input devices 726. Thus, for example, a USB port may be used to provide input to the computer 702 and to output information from computer 702 to an output device 730.

Output adapter 732 is provided to illustrate that there are some output devices 730 like monitors, speakers, and printers, among other output devices 730, which are accessible via adapters. The output adapters 732 include, by way of illustration and not limitation, video and sound cards that provide a means of connection between the output device 730 and the system bus 708. It can be noted that other devices and systems of devices provide both input and output capabilities such as remote computing devices 734.

The computer 702 can be a server hosting various software applications in a networked environment using logical connections to one or more remote computers, such as remote computing devices 734. The remote computing devices 734 may be client systems configured with web browsers, PC applications, mobile phone applications, and the like. The remote computing devices 734 can be a personal computer, a server, a router, a network PC, a workstation, a microprocessor based appliance, a mobile phone, a peer device or other common network node and the like, and typically includes many or all of the elements described relative to the computer 702.

Remote computing devices 734 can be logically connected to the computer 702 through a network interface 736 and then connected via a communication connection 738, which may be wireless. Network interface 736 encompasses wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection 738 refers to the hardware/software employed to connect the network interface 736 to the bus 708. While communication connection 738 is shown for illustrative clarity inside computer 702, it can also be external to the computer 702. The hardware/software for connection to the network interface 736 may include, for exemplary purposes, internal and external technologies such as, mobile phone switches, modems including regular telephone grade modems, cable modems and DSL modems, ISDN adapters, and Ethernet cards.

The computer 702 can further include a radio 740. For example, the radio 740 can be a wireless local area network radio that may operate one or more wireless bands. For example, the radio 740 can operate on the industrial, scientific, and medical (ISM) radio band at 2.4 GHz or 5 GHz. In some examples, the radio 740 can operate on any suitable radio band at any radio frequency.

The computer 702 includes one or more modules 722, such as a composite task manager 742, an action manager 744, a global state tracker 746, and a policy execution manager 748. The composite task manager 742, action manager 744, global state tracker 746, and policy execution manager 748 can implement an agent, such as agent 200 of FIG. 2, which can include concepts from FIGS. 2-3, and 5-6. In some embodiments, the composite task manager 742 can detect a composite task from a user. The composite task manager 742 can also detect a plurality of subtasks corresponding to the composite task based on unsupervised data without a label, wherein the plurality of subtasks are identified by a top-level dialog policy. In some embodiments, the action manager 744 can detect a plurality of actions, wherein each action is to complete one of the subtasks, and wherein each action is identified by a low-level dialog policy corresponding to the subtasks identified by a top-level dialog policy. In some embodiments, the global state tracker 746 can update a global state tracker of a dialog manager or agent based on a completion of each action corresponding to the subtasks, wherein the global state tracker stores an intrinsic value indicating a sub-cost to execute each action, and an extrinsic value indicating a global cost to execute a plurality of actions. In some embodiments, the policy execution manager 748 can execute instructions based on a policy identified by the global state tracker, wherein the executed instructions implement the policy with a lowest global cost corresponding to the composite task provided by the user.

It is to be understood that the block diagram of FIG. 7 is not intended to indicate that the computing system 702 is to include all of the components shown in FIG. 7. Rather, the computing system 702 can include fewer or additional components not illustrated in FIG. 7 (e.g., additional applications, additional modules, additional memory devices, additional network interfaces, etc.). Furthermore, any of the functionalities of the composite task manager 742, action manager 744, global state tracker 746, and policy execution manager 748 may be partially, or entirely, implemented in hardware and/or in the processing unit (also referred to herein as a processor) 704. For example, the functionality may be implemented with an application specific integrated circuit, in logic implemented in the processing unit 704, or in any other device.

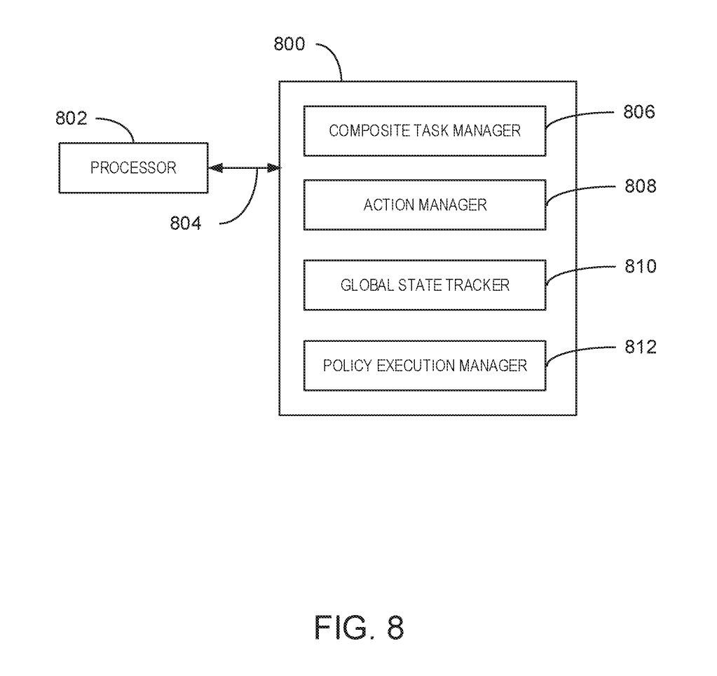

FIG. 8 is a block diagram of an example computer-readable storage media that can execute tasks based on computational learning techniques. The tangible, computer-readable storage media 800 may be accessed by a processor 802 over a computer bus 804. Furthermore, the tangible, computer-readable storage media 800 may include code to direct the processor 802 to perform the steps of the current method.

The various software components discussed herein may be stored on the tangible, computer-readable storage media 800, as indicated in FIG. 8. For example, the tangible computer-readable storage media 800 can include a composite task manager 806 that can detect a composite task from a user, wherein the composite task comprises a plurality of subtasks identified by a top-level dialog policy. In some embodiments, an action manager 808 can detect a plurality of actions, wherein each action is to complete one of the subtasks, and wherein each action is identified by a low-level dialog policy corresponding to the subtasks identified by a top-level dialog policy. In some embodiments, a global state tracker 810 can update a global state tracker based on a completion of each action corresponding to the subtasks, wherein the global state tracker stores an intrinsic value indicating a sub-cost to execute each action, and an extrinsic value indicating a global cost to execute a plurality of actions. In some embodiments, a policy execution manager 812 can execute instructions based on a policy identified by the global state tracker, wherein the executed instructions implement the policy with a lowest global cost corresponding to the composite task provided by the user.

It is to be understood that any number of additional software components not shown in FIG. 8 may be included within the tangible, computer-readable storage media 800, depending on the specific application.

### Example 1

In one embodiment, a system for executing composite tasks based on computational learning techniques can include a processor to detect a composite task from a user. The processor can also detect a plurality of subtasks corresponding to the composite task based on unsupervised data without a label, wherein the plurality of subtasks are identified by a top-level dialog policy. Additionally, the processor can detect a plurality of actions, wherein each action is to complete one of the subtasks, and wherein each action is identified by a low-level dialog policy corresponding to the subtasks identified by the top-level dialog policy. Furthermore, the processor can update a dialog manager based on a completion of each action corresponding to the subtasks, wherein the dialog manager stores an intrinsic value indicating a sub-cost to execute each action corresponding to each subtask, and an extrinsic value indicating a global cost to execute a plurality of actions that perform the composite task. Moreover, the processor can execute instructions based on a policy identified by the dialog manager, wherein the executed instructions implement the policy with a lowest global cost corresponding to the composite task provided by the user.

Alternatively, or in addition, the action is a multi-step action. Alternatively, or in addition, the processor is to detect a number of the plurality of subtasks based on a predetermined upper limit on a maximum number of allowed segmentations. Alternatively, or in addition, the processor is to select each action corresponding to each subtask based on the extrinsic value corresponding to previous identified actions executed in previous states. Alternatively, or in addition, the processor is to calculate a probability that each of the subtasks is to output a termination symbol, and terminate at least one of the subtasks in response to detecting the probability of outputting the termination symbol is above a threshold value. Alternatively, or in addition, the processor is to determine an order of the subtasks based on temporal constraints for each of the subtasks. Alternatively, or in addition, the processor is to generate a first neural network for the high level dialog and a second neural network for the low level dialog. Alternatively, or in addition, the processor is to detect the composite task from a natural language dialog request. Alternatively, or in addition, the plurality of actions comprise transmitting data to a plurality of databases corresponding to the subtasks of the composite task.

### Example 2

In another embodiment, a method for executing composite tasks based on computational learning techniques can include detecting a composite task from a user. The method can also include detecting a plurality of subtasks corresponding to the composite task based on unsupervised data without a label, wherein the plurality of subtasks are identified by a top-level dialog policy. Additionally, the method can also include detecting a plurality of actions, wherein each action is to complete one of the subtasks, and wherein each action is identified by a low-level dialog policy corresponding to the subtasks identified by the top-level dialog policy. Furthermore, the method can also include updating a dialog manager based on a completion of each action corresponding to the subtasks, wherein the dialog manager stores an intrinsic value indicating a sub-cost to execute each action corresponding to each subtask, and an extrinsic value indicating a global cost to execute a plurality of actions that perform the composite task. Moreover, the method can also include executing instructions based on a policy identified by the dialog manager, wherein the executed instructions implement the policy with a lowest global cost corresponding to the composite task provided by the user.

Alternatively, or in addition, the action is a multi-step action. Alternatively, or in addition, the method can also include detecting a number of the plurality of subtasks based on a predetermined upper limit on a maximum number of allowed segmentations. Alternatively, or in addition, the method can also include selecting each action corresponding to each subtask based on the extrinsic value corresponding to previous identified actions executed in previous states. Alternatively, or in addition, the method can also include calculating a probability that each of the subtasks is to output a termination symbol, and terminating at least one of the subtasks in response to detecting the probability of outputting the termination symbol is above a threshold value. Alternatively, or in addition, the method can also include determining an order of the subtasks based on temporal constraints for each of the subtasks. Alternatively, or in addition, the method can also include generating a first neural network for the high level dialog and a second neural network for the low level dialog. Alternatively, or in addition, the method can also include detecting the composite task from a natural language dialog request. Alternatively, or in addition, the plurality of actions comprise transmitting data to a plurality of databases corresponding to the subtasks of the composite task.

### Example 3

In another embodiment, one or more computer-readable storage media for executing composite tasks based on computational learning techniques can include a plurality of instructions that, in response to execution by a processor, cause the processor to detect a composite task from a user. The plurality of instructions can also cause the processor to detect a plurality of subtasks corresponding to the composite task based on unsupervised data without a label, wherein the plurality of subtasks are identified by a top-level dialog policy. Additionally, the plurality of instructions can also cause the processor to detect a plurality of actions, wherein each action is to complete one of the subtasks, and wherein each action is identified by a low-level dialog policy corresponding to the subtasks identified by the top-level dialog policy. Furthermore, the plurality of instructions can also cause the processor to update a dialog manager based on a completion of each action corresponding to the subtasks, wherein the dialog manager stores an intrinsic value indicating a sub-cost to execute each action corresponding to each subtask, and an extrinsic value indicating a global cost to execute a plurality of actions that perform the composite task. Moreover, the plurality of instructions can also cause the processor to execute instructions based on a policy identified by the dialog manager, wherein the executed instructions implement the policy with a lowest global cost corresponding to the composite task provided by the user.

Alternatively, or in addition, the action is a multi-step action. Alternatively, or in addition, the plurality of instructions can also cause the processor to detect a number of the plurality of subtasks based on a predetermined upper limit on a maximum number of allowed segmentations. Alternatively, or in addition, the plurality of instructions can also cause the processor to select each action corresponding to each subtask based on the extrinsic value corresponding to previous identified actions executed in previous states. Alternatively, or in addition, the plurality of instructions can also cause the processor to calculate a probability that each of the subtasks is to output a termination symbol, and terminate at least one of the subtasks in response to detecting the probability of outputting the termination symbol is above a threshold value. Alternatively, or in addition, the plurality of instructions can also cause the processor to determine an order of the subtasks based on temporal constraints for each of the subtasks. Alternatively, or in addition, the plurality of instructions can also cause the processor to generate a first neural network for the high level dialog and a second neural network for the low level dialog. Alternatively, or in addition, the plurality of instructions can also cause the processor to detect the composite task from a natural language dialog request. Alternatively, or in addition, the plurality of actions comprise transmitting data to a plurality of databases corresponding to the subtasks of the composite task.

In particular and in regard to the various functions performed by the above described components, devices, circuits, systems and the like, the terms (including a reference to a “means”) used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned systems have been described with respect to interoperation between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the claimed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system for executing composite tasks based on computational learning techniques comprising:
a processor to:
detect a composite task from a user;
detect a plurality of subtasks corresponding to the composite task based on unsupervised data without a label, wherein the plurality of subtasks are identified by a top-level dialog policy;
detect a plurality of actions, wherein each action is to complete one of the subtasks, and wherein each action is identified by a low-level dialog policy corresponding to the subtasks identified by the top-level dialog policy;
update a dialog manager based on a completion of each action corresponding to the subtasks, wherein the dialog manager stores an intrinsic value indicating a sub-cost to execute each action corresponding to each subtask, and an extrinsic value indicating a global cost to execute a plurality of actions that perform the composite task; and
execute instructions based on a policy identified by the dialog manager, wherein the executed instructions implement the policy with a lowest global cost corresponding to the composite task provided by the user.

2. The system of claim 1, wherein the action is a multi-step action.

3. The system of claim 2, wherein the processor is to detect a number of the plurality of subtasks based on a predetermined upper limit on a maximum number of allowed segmentations.

4. The system of claim 1, wherein the processor is to select each action corresponding to each subtask based on the extrinsic value corresponding to previous identified actions executed in previous states.

5. The system of claim 1, wherein the processor is to:
calculate a probability that each of the subtasks is to output a termination symbol; and
terminate at least one of the subtasks in response to detecting the probability of outputting the termination symbol is above a threshold value.

6. The system of claim 1, wherein the processor is to determine an order of the subtasks based on temporal constraints for each of the subtasks.

7. The system of claim 1, wherein the processor is to generate a first neural network for the high level dialog and a second neural network for the low level dialog.

8. The system of claim 1, wherein the processor is to detect the composite task from a natural language dialog request.

9. The system of claim 8, wherein the plurality of actions comprise transmitting data to a plurality of databases corresponding to the subtasks of the composite task.

10. A method for executing composite tasks based on computational learning techniques comprising:
detecting a composite task from a user;
detecting a plurality of subtasks corresponding to the composite task based on unsupervised data without a label, wherein the plurality of subtasks are identified by a top-level dialog policy;
detecting a plurality of actions, wherein each action is to complete one of the subtasks, and wherein each action is identified by a low-level dialog policy corresponding to the subtasks identified by the top-level dialog policy;
updating a dialog manager based on a completion of each action corresponding to the subtasks, wherein the dialog manager stores an intrinsic value indicating a sub-cost to execute each action corresponding to each subtask, and an extrinsic value indicating a global cost to execute a plurality of actions that perform the composite task; and
executing instructions based on a policy identified by the dialog manager, wherein the executed instructions implement the policy with a lowest global cost corresponding to the composite task provided by the user.

11. The method of claim 10, wherein the action is a multi-step action.

12. The method of claim 10, further comprising detecting a number of the plurality of subtasks based on a predetermined upper limit on a maximum number of allowed segmentations.

13. The method of claim 10, further comprising selecting each action corresponding to each subtask based on the extrinsic value corresponding to previous identified actions executed in previous states.

14. The method of claim 10, further comprising:
calculating a probability that each of the subtasks is to output a termination symbol; and
terminating at least one of the subtasks in response to detecting the probability of outputting the termination symbol is above a threshold value.

15. The method of claim 10, further comprising determining an order of the subtasks based on temporal constraints for each of the subtasks.

16. The method of claim 10, further comprising generating a first neural network for the high level dialog and a second neural network for the low level dialog.

17. The method of claim 10, further comprising detecting the composite task from a natural language dialog request.

18. The method of claim 17, wherein the plurality of actions comprise transmitting data to a plurality of databases corresponding to the subtasks of the composite task.

19. One or more computer-readable storage media for executing composite tasks based on computational learning techniques comprising a plurality of instructions that, in response to execution by a processor, cause the processor to:
detect a composite task from a user;
detect a plurality of subtasks corresponding to the composite task based on unsupervised data without a label, wherein the plurality of subtasks are identified by a top-level dialog policy;
detect a plurality of actions, wherein each action is to complete one of the subtasks, and wherein each action is identified by a low-level dialog policy corresponding to the subtasks identified by the top-level dialog policy;
update a dialog manager based on a completion of each action corresponding to the subtasks, wherein the dialog manager stores an intrinsic value indicating a sub-cost to execute each action corresponding to each subtask, and an extrinsic value indicating a global cost to execute a plurality of actions that perform the composite task; and
execute instructions based on a policy identified by the dialog manager, wherein the executed instructions implement the policy with a lowest global cost corresponding to the composite task provided by the user.

20. The one or more computer-readable storage media of claim 19, wherein the processor is to detect a number of the plurality of subtasks based on a predetermined upper limit on a maximum number of allowed segmentations.
